(19) United States
(12) Patent Application Publication
(10) Pub. No.: US 2009/0251403 A1
(43) Pub. Date: Oct. 8, 2009

(54) LIQUID CRYSTAL DISPLAY PANEL

(75) Inventor: Ping-Po Chen, Tainan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HIMAX TECHNOLOGIES LIMITED, Tainan County (TW)

(21) Appl. No.: 12/098,504

(22) Filed: Apr. 7, 2008

(51) Int. Cl. G09G 3/36

(52) U.S. Cl. 345/103

(57) ABSTRACT

A liquid crystal display panel. The liquid crystal display panel comprises a first display matrix, a second display matrix, a first gate electrode group, a second gate electrode group and a data electrodes group. The first display matrix comprises first display cells arranged in N rows and M columns; the second display matrix comprises second display cells arranged in N rows and M columns. The first gate electrode group comprises first gate electrodes respectively coupled to the first display matrix and the second gate electrode group comprises second gate electrodes respectively coupled to the second display matrix. The data electrodes group comprises data electrodes respectively coupled to the first display matrix and the second display matrix, wherein an m-th data electrode is coupled to an m-th column of the first display cells and an m-th column of the second display cells.

### BACKGROUND OF THE INVENTION

1. Field of the Invention

The invention relates to a Liquid Crystal Display (LCD) panel, and more particularly to a driving circuit for driving an LCD panel.

2. Description of the Related Art

An Liquid Crystal Display (LCD) is made up of a plurality of color or monochrome pixels arrayed in front of a light source or reflector. In forming an LCD device, a liquid crystal layer is inserted between two glass substrates, wherein the first substrate has a color filter, and the second substrate has transistors in it. As the current pass through the transistors, the electric field is introduced and the liquid crystal will be deflected. The rotation of the polarization of the incident light changes the direction of the incident light as it pass through the liquid crystal layer, and this light will then pass through the filter which filters out the light with different polarizations. By controlling the voltage applied across the liquid crystal layer in each pixel, light can be allowed to pass through in varying amounts, correspondingly illuminating the pixel.

FIG. 1 is a schematic diagram of a conventional LCD panel and the peripheral driving circuits thereof. As shown in the figure, an LCD panel 1 is formed by interlacing data electrodes (represented by D₁, D₂, D₃, . . . , Dₘ) and gate electrodes (represented by G₁, G₂, G₃, . . . , Gₘ), wherein each pair of which controls a display cell. As an example, interlacing data electrode D₁ and gate electrode G₁ control display cell 100. The equivalent circuit of each display cell comprises thin film transistors (TFTs) (Q₁₁-Q₁ₘ, Q₂₁-Q₂ₘ, . . . , Qₙ₁-Qₙₘ) and storage capacitors (C₁₁-C₁ₘ, C₂₁-C₂ₘ, . . . , Cₙ₁-Cₙₘ). The gates and drains of the TFTs are respectively connected to gate electrodes (G₁˜Gₙ) and data electrodes (D₁˜Dₘ). Such a connection can turn on or off all TFTs on the same line (i.e. positioned on the same scan line) using a scan signal of gate electrodes (G₁˜Gₙ), thereby controlling the video signals of the data electrodes to be written into the corresponding display cell. It is noted that a display cell only controls the brightness of a single pixel on the LCD panel.

Accordingly, each display cell responds to a single pixel on a monochromatic LCD, but to a single subpixel on a color LCD. The subpixel can be red (represented by “R”), blue (represented by “B”), or green (represented by “G”). In other words, a single pixel is formed by an RGB (three display cells) combination.

Recently, with the development different panel sizes of the LCD panel, requirement for higher display resolution has increased. However, increasing display resolution also increases the complexity of the driving circuits. Additionally, compromising between the total PAD number, COG bumping pad pitch and mask limitation, is an important consideration when designing high resolution LCD panels. Thus, an improved driving circuit is needed for driving high resolution LCD panels with reduced circuit complexity, which results in achieving a more efficient compromise between the PAD number, COG bumping pad pitch and mask limitation.

### BRIEF SUMMARY OF THE INVENTION

Liquid crystal display panel are provided. An exemplary embodiment of a liquid crystal display panel comprises a first display matrix, a second display matrix, a first gate electrode group, a second gate electrode group and a data electrodes group. The first display matrix comprises first display cells arranged in N rows and M columns and the second display matrix comprises second display cells arranged in N rows and M columns. The first gate electrode group comprises first gate electrodes respectively coupled to the first display matrix and the second gate electrode group comprises second gate electrodes respectively coupled to the second display matrix. The data electrodes group comprises data electrodes respectively coupled to the first display matrix and the second display matrix, wherein an m-th data electrode is coupled to an m-th column of the first display cells and an m-th column of the second display cells.

Another exemplary embodiment of a liquid crystal display panel comprises a first display cell, a second display cell, a third display cell, a fourth display cell, a first gate electrode, a second gate electrode, a first data electrode and a second data. The first display cell, the second display cell, the third display cell and the fourth display cell are arranged in a first display cell array. The first gate electrode is coupled to the first display cell and the second display cell. The second gate electrode is coupled to the third display cell and the fourth display cell, and the first gate electrode and the second gate electrode are aligned. The first data electrode is coupled to the first display cell and the third display cell. The second data electrode is coupled to the second display cell and the fourth display cell.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a schematic diagram of a conventional LCD panel and the peripheral driving circuits thereof; and

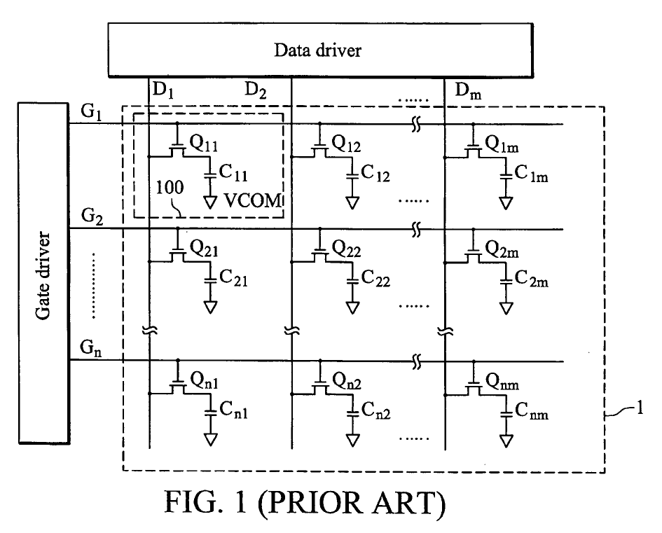

FIG. 2 illustrates an LCD panel with utilizing driving circuits according to one embodiment of the invention;

FIG. 3 illustrates the driving waveform according to one embodiment of the invention; and

FIG. 4 illustrates an example of the data polarity in a 4×4 display cells according to the embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

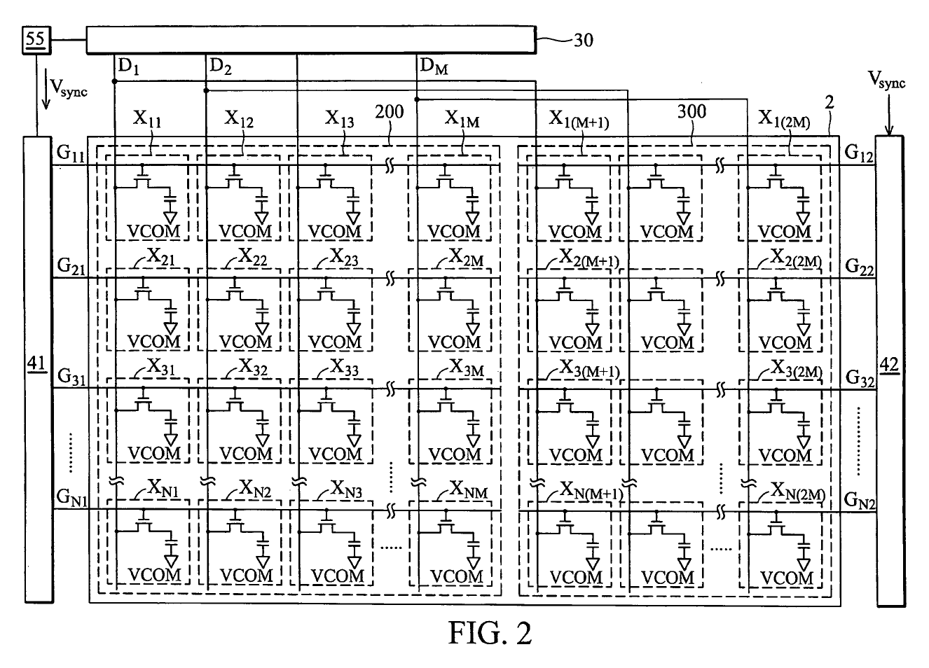

FIG. 2 illustrates an LCD panel utilizing driving circuits according to one embodiment of the invention. LCD panel 2 displays images according to an image control signal provided by a host and comprises N×2M display cells (represented by X₁₁, X₁₂, X₁₃, . . . , X_{1M}, X_{1(M+1)}, . . . , X_{1(2M)}, X₂₁, X₂₂, X₂₃, . . . , X_{2M}, X_{2(M+1}), . . . , X_{2(2M)}, . . . , X_{N(2M)}), wherein the display cells can further be divided into two display matrixes 200 and 300, each comprising N×M display cells (hereinafter called first display cells for display matrix 200 and second display cells for display matrix 300). As shown in the figure, gate electrodes G₁₁, G₂₁, G₃₁, . . . , G_{N1} form a first gate electrode group and are coupled to the first gate driver 41, wherein first gate driver 41 outputs a plurality of first scan signals to the first gate electrode group. Gate electrodes G₁₂, G₂₂, G₃₂, . . . , G_{N2} form a second gate electrode group and are coupled to the second gate driver 42, wherein second gate driver 42 outputs a plurality of second scan signals to the second gate electrode group. Data electrodes D₁, D₂, D₃, . . . , D_{M} form a data electrode group and are coupled to the data driver 30, wherein data driver 30 outputs a plurality of data signals to the data electrode group. The gate electrodes G₁₁, G₂₁, G₃₁, . . . , G_{N1} are also coupled to the display matrix 200, wherein n-th gate electrode Gₙ₁ in the first gate electrode group is coupled to the n-th row of the first display cells Xₙ₁˜X_{nM} (n=1˜N). The gate electrodes G₁₂, G₂₂, G₃₂, . . . , G_{N2} are also coupled to the display matrix 300, wherein n-th gate electrode Gₙ₂ in the second gate electrode group is coupled to the n-th row of the second display cells X_{n(M+1)}˜X_{n(2M)} (n=1˜N). The data electrodes D₁, D₂, D₃, . . . , D_{M} are also coupled to the display matrixes 200 and 300, wherein m-th data electrode Dₘ in the data electrode group is coupled to the m-th column of the first display cells X₁ₘ˜X_{Nm} (m=1˜M) and m-th column of the second display cells X_{1(m+M)}˜X_{N(m+M)} (m=1˜M). As shown in FIG. 2, the m-th column of the first display cells in display matrix 200 and the m-th column of the second display cells in display matrix 300 are not adjacent to each other. The driving operation of the LCD panel is described in the following.

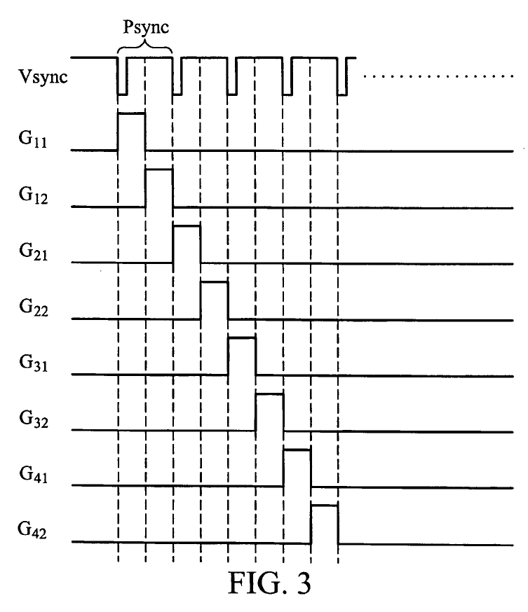

In order to control the scan timing of the LCD panel, LCD panel 2 further comprises a timing controller 55. The timing controller outputs a vertical synchronization signal Vsync for controlling the signal timing of the data electrode group, the first gate electrode group and the second gate electrode group. FIG. 3 illustrates the driving waveform according to one embodiment of the invention. As shown in FIG. 3, synchronization signal Vsync comprises a plurality of square waves having periods of high voltage level and low voltage level, and in one period Psync of the square wave, gate electrodes output scan signals to one row of the display cells in the display matrixes 200 and 300. Thus, the TFTs within all display cells on the same row are turned on while the TFTs within all display cells on other rows may be turned off. According to the embodiment, during the fore half of the period of an n-th square wave, the n-th gate electrode Gₙ₁ in the first gate electrode group outputs the first scan signal for selecting the n-th row of the first display cells Xₙ₁˜X_{nM} in the display matrix 200 (n=1˜N). At this time, each data electrodes D₁˜D_{M} outputs the corresponding data signals to the corresponding columns of the n-th row of the first display cells Xₙ₁˜X_{nM}, respectively. During the aft half of the period of the n-th square wave, the n-th gate electrode Gₙ₂ outputs the second scan signal for selecting the n-th row of the second display cells X_{n(M+1)}˜X_{n(2M)} in the display matrix 300 (n=1N). At this time, each data electrodes D₁˜D_{M} outputs the corresponding data signals to the corresponding columns of the n-th row of the second display cells X_{n(M+1)}˜X_{n(2M)}, respectively.

Based on the design described above, the total number of the data electrodes is reduced to half of the amount of the display columns in the LCD panel, and the total number of the gate electrodes is twice as the amount of the display rows in the LCD panel. For example, as shown in FIG. 2, the total number of data electrodes is M and the total number of the gate electrodes is 2N while the resolution of the LCD panel 2 is N×2M. For a high resolution color display panel that needs triple data electrodes for providing red, green and blue colors respectively, the total number of data electrodes while applying the driving circuit of the invention is greatly reduced. For example, for a 272×480 resolution color display panel, the total number of gate electrodes and data electrodes is 1712 (272+480×3=1712) for a conventional driving circuit. However, based on the driving circuit as shown in FIG. 2 of the invention, the total number of gate electrodes and data electrodes can be reduced to 1264 (272×2+480÷2×3=1264), or 448 electrodes less, when compared to conventional driving circuits.

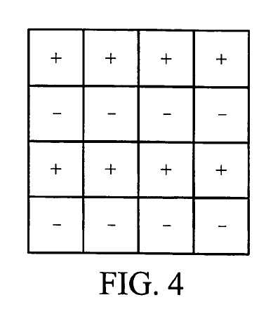

FIG. 4 illustrates an example of the data polarity in a 4×4 display cells according to the embodiment of the invention. In this example, the LCD panel 2 comprises N=4 and M=2, thus, the 4×4 display panel comprises display cells X₁₁˜X₁₄, X₂₁˜X₂₄, X₃₁˜X₃₄, X₄₁˜X₄₄, and data electrodes D₁˜D₂, first gate electrodes G₁₁˜G₄₁ and second gate electrodes G₁₂˜G₄₂. As shown in FIG. 4, for example, when the first gate electrode G₁₁ outputs the first scan signal for selecting the first row display cells X₁₁˜X₁₂, and the data electrodes D₁˜D₂ output the corresponding data signals with positive polarity (labeled with ‘+’ in FIG. 4) to the corresponding columns in the first row display cells X₁₁˜X₁₂, and when the second gate electrode G₁₂ outputs the second scan signal for selecting the first row display cells X₁₃˜X₁₄, and the data electrodes D₁˜D₂ output the corresponding data signals with positive polarity to the corresponding columns in the first row display cells X₁₃˜X₁₄, the data electrodes D₁˜D₂ output the corresponding data signals with negative polarity (labeled with ‘−’ in FIG. 4) to the corresponding columns in second row display cells X₂₁˜X₂₂ when the first gate electrode G₂₁ outputs the first scan signal for selecting the second row display cells X₂₁˜X₂₂, and the data electrodes D₁˜D₂ output the corresponding data signals with negative polarity to the corresponding columns in second row display cells X₂₃˜X₂₄ when the second gate electrode G₂₂ outputs the second scan signal for selecting the second row display cells X₂₃˜X₂₄. Additionally, the data polarity of the third row display cells X₃₁˜X₃₄ and the fourth row display cells X₄₁˜X₄₄ follow the same pattern as the first row display cells X₁₁˜X₁₄ and the second row display cells X₂₁˜X₂₄.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A liquid crystal display panel for displaying images according to an image control signal provided by a host, comprising:
a first display matrix comprising a plurality of first display cells arranged in N rows and M columns;
a second display matrix comprising a plurality of second display cells arranged in N rows and M columns;
a first gate electrode group comprising a plurality of first gate electrodes respectively coupled to the first display matrix, wherein an n-th first gate electrode is coupled to an n-th row of the first display cells in the first display matrix;
a second gate electrode group comprising a plurality of second gate electrodes respectively coupled to the second display matrix, wherein an n-th second gate electrode is coupled to an n-th row of the second display cells in the second display matrix; and
a data electrodes group comprising a plurality of data electrodes respectively coupled to the first display matrix and the second display matrix, wherein an m-th data electrode is coupled to an m-th column of the first display cells and an m-th column of the second display cells, wherein the m-th column of the first display cells and the m-th column of the second display cells are not adjacent to each other.

2. The liquid crystal display panel as claimed in claim 1, wherein the n-th first gate electrode and the n-th second gate electrode are aligned.

3. The liquid crystal display panel as claimed in claim 1, further comprising:
a first gate driver outputting a plurality of first scan signals to the first gate electrode group;
a second gate driver outputting a plurality of second scan signals to the second gate electrode group; and
a data driver outputting a plurality of data signals to the data electrode group.

4. The liquid crystal display panel as claimed in claim 3, wherein when the n-th first gate electrode outputs the first scan signal for selecting the n-th row of the first display cells, the data electrodes output the corresponding data signals with positive polarity to the corresponding columns in the n-th row of the first display cells, and when the n-th second gate electrode outputs the second scan signal for selecting the n-th row of the second display cells, the data electrodes output the corresponding data signals with positive polarity to the corresponding columns in the n-th row of the second display cells, the data electrodes output the corresponding data signals with negative polarity to the corresponding columns in (n+1)-th row of the first display cells when the (n+1)-th first gate electrode outputs the first scan signal for selecting the (n+1)-th row of the first display cells, and the data electrodes output the corresponding data signals with negative polarity to the corresponding columns in (n+1)-th row of the second display cells when the (n+1)-th second gate electrode outputs the second scan signal for selecting the (n+1)-th row of the second display cells.

5. The liquid crystal display panel as claimed in claim 3, further comprising a timing controller, wherein the timing controller outputs a synchronization signal for controlling the signal timing of the data electrode group, the first gate electrode group and the second gate electrode group, and the synchronization signal comprises a plurality of square waves having periods of high voltage level and low voltage level, and wherein during the fore half of the period of an n-th square wave, the n-th first gate electrode outputs the first scan signal for selecting the n-th row of the first display cells, and each data electrodes outputs the corresponding data signals to the corresponding columns of the first display cells respectively, and during the aft half of the period of the n-th square wave, the n-th second gate electrode outputs the second scan signal for selecting the n-th row of the second display cells, and each data electrodes outputs the corresponding data signals to the corresponding columns of the second display cells respectively.

6. A liquid crystal display panel for displaying images according to an image control signal provided by a host, comprising:
a first display cell;
a second display cell;
a third display cell, wherein the first display cell and the third display cell are not adjacent to each other;
a fourth display cell;
a first gate electrode coupled to the first display cell and the second display cell;
a second gate electrode coupled to the third display cell and the fourth display cell, wherein the first gate electrode and the second gate electrode are aligned;
a first data electrode coupled to the first display cell and the third display cell; and
a second data electrode coupled to the second display cell and the fourth display cell.

7. The liquid crystal display panel as claimed in claim 6, wherein the second display cell and the fourth display cell are not adjacent to each other.

8. The liquid crystal display panel as claimed in claim 6, further comprising:
a first gate driver outputting a plurality of first scan signals to the first gate electrode;
a second gate driver outputting a plurality of second scan signals to the second gate electrode; and
a data driver outputting a plurality of first data signals to the first data electrode and a plurality of second data signals to the second data electrode.

9. The liquid crystal display panel as claimed in claim 8, further comprising:
a fifth display cell coupled to the first data electrode;
a sixth display cell coupled to the second data electrode;
a seventh display cell coupled to the first data electrode;
a eighth display cell coupled to the second data electrode;
a third gate electrode coupled to the fifth display cell and the sixth display cell; and
a fourth gate electrode coupled to the seventh display cell and the eighth display cell, wherein the third gate electrode and the fourth gate electrode are aligned.

10. The liquid crystal display panel as claimed in claim 9, wherein the fifth display cell and the seventh display cell are not adjacent to each other.

11. The liquid crystal display panel as claimed in claim 9, wherein the sixth display cell and the eighth display cell are not adjacent to each other.

12. The liquid crystal display panel as claimed in claim 9, wherein the first gate driver further outputs a plurality of third scan signals to the third gate electrode, and the second gate driver further outputs a plurality of fourth scan signals to the fourth gate electrode.

13. The liquid crystal display panel as claimed in claim 12, wherein when the first gate driver outputs the first scan signals to the first gate electrode for selecting the first display cell and the second display cell, the data driver outputs the first data signals to the first display cell and the second data signals to the second display cell, and when the second gate driver outputs the second scan signals to the second gate electrode for selecting the third display cell and the fourth display cell, the data driver outputs the first data signals to the third display cell and the second data signals to the fourth display cell.

14. The liquid crystal display panel as claimed in claim 13, wherein when the first gate driver outputs the third scan signals to the third gate electrode for selecting the fifth display cell and the sixth display cell, the data driver outputs the first data signals to the fifth display cell and the second data signals to the sixth display cell, and when the second gate driver outputs the fourth scan signals to the fourth gate electrode for selecting the seventh display cell and the eighth display cell, the data driver outputs the first data signals to the seventh display cell and the second data signals to the eighth display cell.

15. The liquid crystal display panel as claimed in claim 14, wherein when the first data signals outputted to the first display cell and the third display cell, and the second data signals outputted to the second display cell and the fourth display cell are with positive polarity, the first data signals outputted to the fifth display cell and the seventh display cell, and the second data signals outputted to the sixth display cell and the eighth display cell are with negative polarity.

16. The liquid crystal display panel as claimed in claim 12, further comprising a timing controller, wherein the timing controller outputs a synchronization signal for controlling the signal timing of the first data electrode, the second data electrode, the first gate electrode, the second gate electrode, the third gate electrode, and the fourth gate electrode, and the synchronization signal comprises a plurality of square waves having periods of high voltage level and low voltage level, and wherein during the fore half of the period of an n-th square wave, the first gate driver outputs the first scan signals to the first gate electrode for selecting the first display cell and the second display cell, and the data driver outputs the first data signals to the first display cell and the second data signals to the second display cell, and during the aft half of the period of the n-th square wave, the second gate driver outputs the second scan signals to the second gate electrode for selecting the third display cell and the fourth display cell, and the data driver outputs the first data signals to the third display cell and the second data signals to the fourth display cell.

17. The liquid crystal display panel as claimed in claim 16, wherein during the fore half of the period of an (n+1)-th square wave, the first gate driver outputs the third scan signals to the third gate electrode for selecting the fifth display cell and the sixth display cell, and the data driver outputs the first data signals to the fifth display cell and the second data signals to the sixth display cell, and during the aft half of the period of the (n+1)-th square wave, the second gate driver outputs the fourth scan signals to the fourth gate electrode for selecting the seventh display cell and the eighth display cell, the data driver outputs the first data signals to the seventh display cell and the second data signals to the eighth display cell.
